(19) United States
(12) Patent Application Publication
(10) Pub. No.: US 2014/0189981 A1
(43) Pub. Date: Jul. 10, 2014

(54) BABY BOTTLE HOLDER

(71) Applicant: LEC, INC., Chuo-ku, Tokyo (JP)

(72) Inventors: Maiko Hotchi, Tokyo (JP); Tomonori Matsumoto, Tokyo (JP); Takane Fujinami, Tokyo (JP)

(73) Assignee: LEC, INC., Chuo-ku, Tokyo (JP)

(21) Appl. No.: 14/111,311

(22) PCT Filed: Dec. 28, 2012
(86) PCT No.: PCT/JP2012/084129

§ 371 Date: Oct. 11, 2013

(30) Foreign Application Priority Data
Nov. 26, 2012 (JP) 2012-257574

(51) Int. Cl. A61J 9/06

(52) U.S. Cl. CPC A61J 9/06
USPC 16/425

(57) ABSTRACT

A baby bottle holder, that fits a shoulder of a bottle body, that prevents slipping, is easily holdable, and has thermally-insulating grips to facilitate preparation of milk, is made of a thermally-insulating and flexible elastic member, and integrally includes a tubular cover and a conical cover therebelow covering the shoulder of the bottle body, and a tongue-shaped grip pair extending downward from symmetrical positions on both sides of the conical cover. Fingers grasp non-slip surfaces of the grips, which provide insulation from heat, and can easily shake the bottle body. During feeding prepared milk, the grasp of the fingers on the non-slip surfaces of the grips prevents slipping-off of the bottle body. An infant's hands can also grasp the grips preventing slipping-off of the bottle body.

### TECHNICAL FIELD

The present invention relates to a baby bottle holder to be attached to a baby bottle designed for an infant to drink milk.

### BACKGROUND ART

FIG. 5 is an exploded perspective view showing a generally-used baby bottle 1. The baby bottle 1, which is designed for an infant to drink milk, includes a bottle body 2 made of glass or transparent synthetic resin, a detachable nipple 3 made of synthetic rubber such as silicone rubber and having a pinhole at the top for suction of the contained milk, and a cap 4 made of synthetic resin to attach and detach the nipple 3 to and from the bottle body 2.

The base of the nipple 3 includes a flange 3a, which fixes the nipple 3 to the cap 4. The inner groove on the inner wall of the cap 4 screws into the outer groove 2a on the upper outer wall of the bottle body 2, so that the cap 4 is attached to the bottle body 2. The flange 3a of the nipple 3 herein also functions as a gasket at the upper edge of the bottle body 2, and thus prevents the contained milk from leaking through the connection between the bottle body 2 and the cap 4.

In general, upon feeding milk with the baby bottle 1, hot water is poured into a predetermined amount of powdered milk in the bottle body 2, then the cap 4 with the nipple 3 is attached, and the bottle body 2 is shaken side to side to dissolve the powdered milk in the hot water and sufficiently cool the dissolved milk before feeding.

Although the bottle body 2 becomes hot due to the hot water poured in the powdered milk, the bottle body 2 is shaken with the grasp on the cap 4 that has low thermal conductivity and does not easily heated, to dissolve the powdered milk.

Patent Literature 1 discloses a baby bottle including a rubber helical portion as a part of the bottle. Patent Literature 2 discloses a detachable feeding supporter including a rubber non-slip device. In addition, Patent Literature 3 discloses a baby bottle with a rubber coating over the bottle body surface to prevent slipping-off of the baby bottle and thermal conductance from hot water.

### CITATION LIST

### Patent Literature

Patent Literature 1: Japanese Unexamined Utility Model Application Publication No. H3-94236

Patent Literature 2: Japanese Patent No. 3119852

Patent Literature 3: Japanese Unexamined Patent Application Publication No. 2002-360667

### SUMMARY OF INVENTION

### Technical Problem

Unfortunately, according to the baby bottle in Patent Literature 1, the helical portion is not a finger grip and thus does not help hold the entire baby bottle. The non-slip device of Patent Literature 2 is also not a finger grip. Thus, although the baby bottles disclosed in Patent Literatures 1 and 2 each have a thermally-insulated portion, hot water for dissolving powdered milk makes the bottle body too hot to be held with hand.

According to Patent Literature 3, although the rubber coating over the entire baby bottle prevents slipping and insulates heat, the rubber coating makes it difficult to determine whether the milk has cooled down enough based on the sensation in the hand touching the baby bottle, and therefore hot milk may be erroneously fed to an infant.

An object of the present invention, which has been accomplished to solve the above problem, is to provide a baby bottle holder of which thermally-insulating grips are easily holdable during preparation of milk with hot water and powdered milk, and which prevents slipping to help the infant's grasp.

### Solution to Problem

To achieve the above object, a baby bottle holder according to the present invention is detachably attached around the shoulder at the upper part of a bottle body, is made of a thermally-insulating and flexible elastic member, and includes a tubular cover having an opening with a diameter approximately the same as the external diameter of the mouth of the bottle body, a substantially conical cover below the tubular cover to cover the shoulder's surface of the bottle body, and tongue-shaped grips extending downward from the lower edge of the conical cover.

### Advantageous Effects of Invention

The baby bottle holder according to the present invention is attached to the baby bottle to allow grasp on the baby bottle containing hot water and to help the infant's grasp during feeding. Furthermore, the baby bottle holder is easily detachable from the bottle body, and therefore is separately washable and sterilizable in a simple manner for hygienic use.

### BRIEF DESCRIPTION OF DRAWINGS

FIG. 1 is a perspective view of a baby bottle holder attached to a bottle body;

FIG. 2 is a perspective view of a bottle body provided with a cap;

FIG. 3 is a perspective view of a baby bottle holder;

FIG. 4 is an illustrative view to explain shaking of a baby bottle for preparation of milk; and

FIG. 5 is an exploded perspective view of a conventional baby bottle.

### DESCRIPTION OF EMBODIMENTS

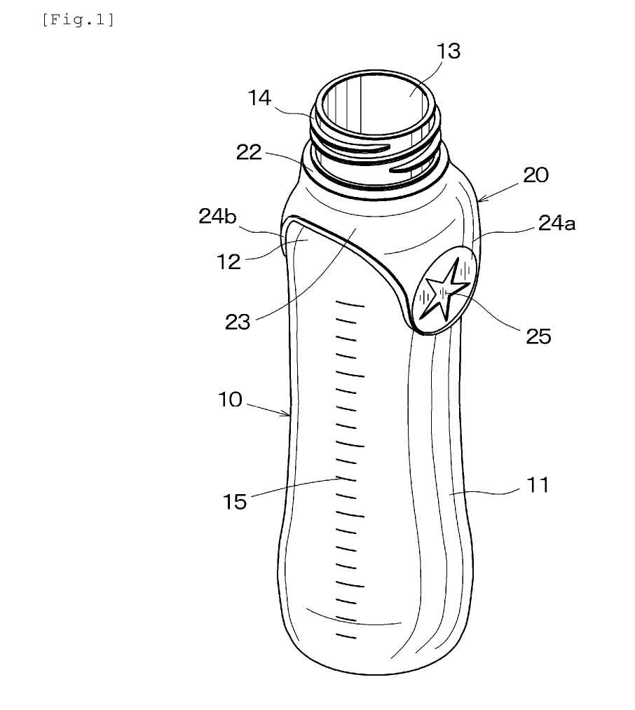

The present invention will now be described in detail based on an embodiment shown in FIGS. 1 to 4.

FIG. 1 is a perspective view of a baby bottle holder 20, which is attached to a commercially-available bottle body 10 made of synthetic resin or glass . The bottle body 10 includes, in order from the bottom, a barrel 11, a shoulder 12, and a tubular mouth 13 with a diameter smaller than that of the barrel 11. The outside of the mouth 13 is provided with an outer groove 14. A scale 15 indicating the volume of milk is printed on the barrel 11 of the bottle body 10. In addition, the baby bottle holder 20 is attached around the shoulder 12 below the mouth 13.

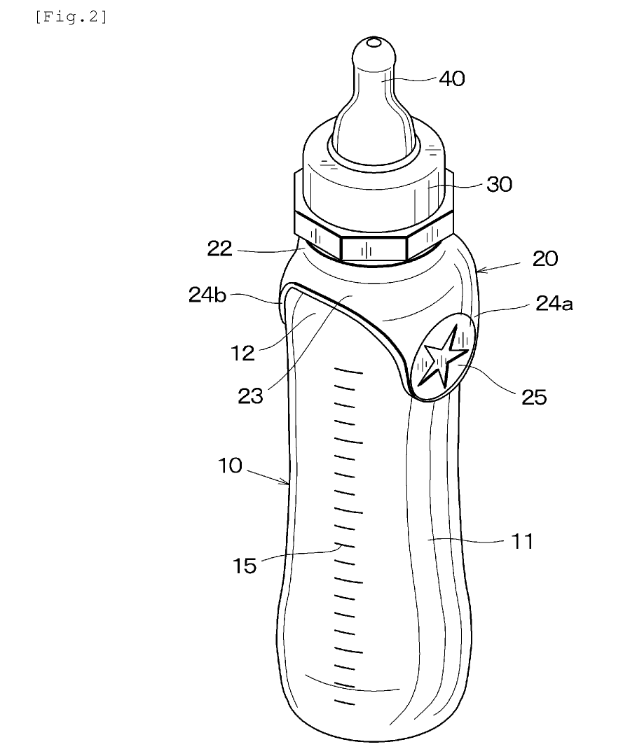

FIG. 2 is a perspective view of a synthetic-resin cap 30 fixed at the top of the bottle body 10 by screwing to the outer groove 14 of the bottle body 10. A nipple 40 made of a material such as silicone rubber is attached to the bottle body 10 via the cap 30.

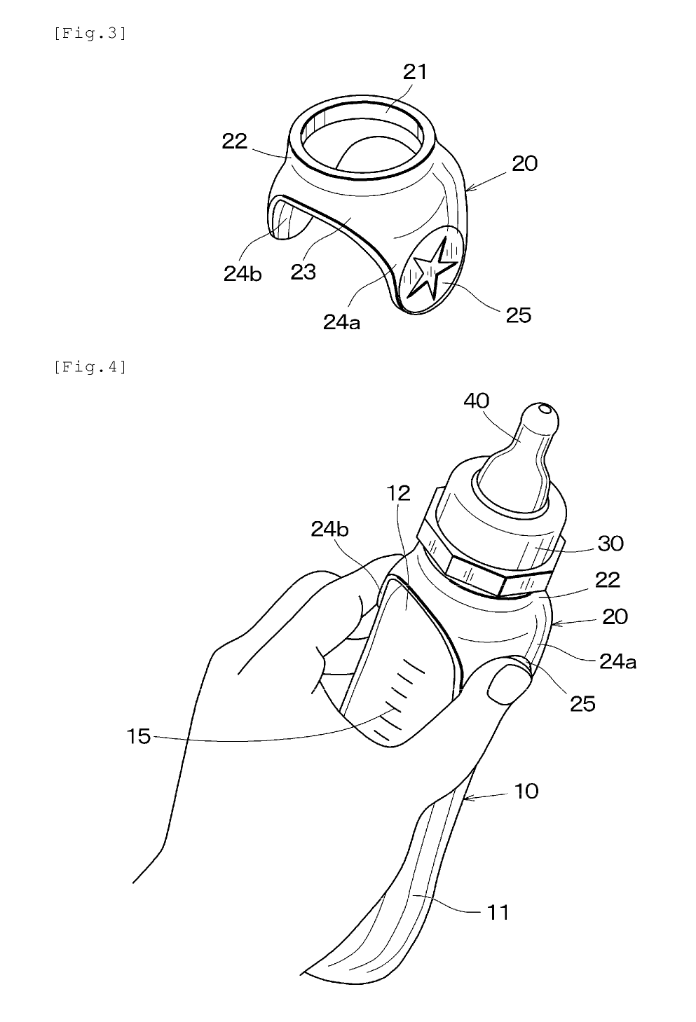

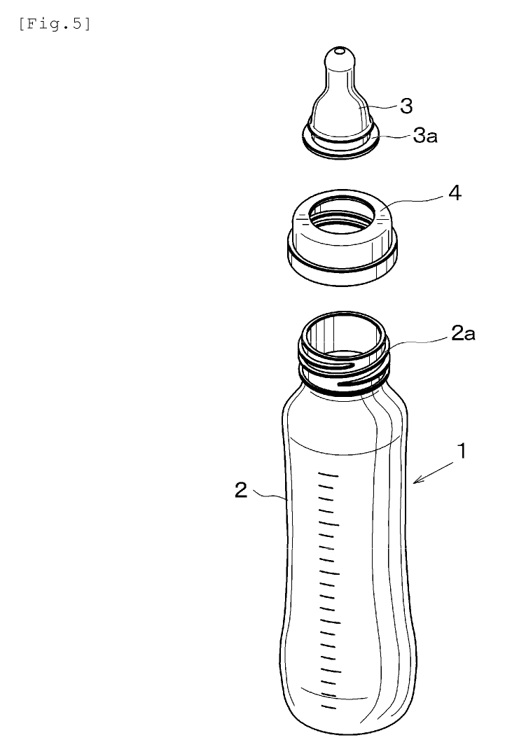

The baby bottle holder 20 is made of an elastic member, such as silicone rubber, having high thermal durability, low thermal conductivity, and flexibility, and having a thickness of about 2 to 5 mm. As shown in FIG. 3, the baby bottle holder 20 is provided integrally with a tubular cover 22 having an opening 21 with a diameter approximately the same as the external diameter of the mouth 13 of the bottle body 10, a substantially conical cover 23 with a divergent shape below the tubular cover 22 to cover the shoulder 12 of the bottle body 10, and a pair of tongue-shaped grips 24a, 24b extending downward from symmetrical positions on both sides of the conical cover 23. The grips 24a, 24b each have an uneven non-slip surface 25.

Upon use, predetermined amounts of powdered milk and hot water are added through the mouth 13 into the bottle body 10, and thereafter the cap 30 with the nipple 40 is screwed and fastened to the bottle body 10. Then, as shown in FIG. 4, the bottle body 10 is shaken side to side with the grips 24a, 24b of the baby bottle holder 20 held between the thumb and other fingers such as the index finger and the middle finger, so that the hot water dissolves the powdered milk.

The fingers herein grasp the non-slip surfaces 25 of the grips 24a, 24b, and therefore are thermally insulated from the hot water. This enables easy shaking of the bottle body 10 for preparation of milk.

Upon feeding the prepared milk, the bottle body 10 is inclined with the mouth 13 down while the grips 24a, 24b are held between the thumb and other fingers. The fingers' grasp on the non-slip surfaces 25 of the grips 24a, 24b keeps the bottle body 10 from slipping off. Also, when an infant holds the bottle body 10, the grasp on the grips 24a, 24b with the infant's both hands prevents slipping.

Since the baby bottle holder 20 covers only the upper part of the bottle body 10, a temperature of the contained milk can be estimated based on the sensation of warmth in the hand touching the portion of the barrel 11 that is not covered with the grips 24a, 24b, similarly to conventional baby bottles.

Moreover, since the grips 24a, 24b are a pair of tongue-shaped components, part of the external surface of the bottle body 10 is not covered with the grips 24a, 24b; that is to say, if the baby bottle holder 20 is attached such that the grips 24a, 24b do not hide the scale 15, indication of the volume with the scale 15 is not interrupted. Also, if falling down sideways, the baby bottle does not easily roll away due to the grips 24a, 24b. The number of grips 24a, 24b is not limited to two as in the present embodiment, and may be three or four, for example.

Furthermore, the baby bottle holder 20 is made of synthetic resin such as silicone rubber, and thus insulates heat as described above, and prevents slipping to help the infant's grasp. The non-slip surfaces 25 may have any pattern or color attractive to infants. For example, in terms of colors, the baby bottle holder 20 entirely colored in vivid colors, such as red, yellow, blue, and green, is likely to attract infants.

The baby bottle holder 20 may be entirely opaque as a matter of course, and may be made of a transparent or semitransparent material. With a transparent or semitransparent material, the scale 15 is readable even if being covered with the grips 24a, 24b of the baby bottle holder 20 shown in FIG. 1, for example. Also, the baby bottle holder 20 may be entirely colored transparent or colored semitransparent, and the individual components, such as the grips 24a, 24b, of the baby bottle holder 20 may be independently transparent, semitransparent, or colored as appropriate.

The baby bottle holder 20 according to the present embodiment is easily detachable from the bottle body 10 by the fingers, and therefore is separately washable and sterilizable in a simple manner for hygienic use. The baby bottle holder 20 is easily detachable from the bottle body 10 by the fingers pinching the tips of the grips 24a, 24b and pulling the grips 24a, 24b inside out.

In general, since a baby bottle requires sterilization after every use, an infant needs several baby bottles. However, the detachable baby bottle holder 20 according to the present embodiment does not require sterilization after every feeding, and therefore can be shared by several bottle bodies 10.

In addition, the baby bottle holder 20 made of synthetic rubber is stretchable, and thus is fittable to most of the variously-shaped baby bottles.

### REFERENCE SIGNS LIST

10 Bottle body

11 Barrel

12 Shoulder

13 Mouth

15 Scale

20 Baby bottle holder

21 Opening

22 Tubular cover

23 Conical cover

24a, 24b Grip

25 Non-slip surface

30 Cap

40 Nipple

1. A baby bottle holder, to be detachably attached around a shoulder at an upper part of a bottle body, comprising:
a thermally-insulating and flexible elastic member;
a tubular cover having an opening with a diameter substantially the same as an external diameter of a mouth of the bottle body;
a substantially conical cover below the tubular cover to cover a surface of the shoulder of the bottle body; and
tongue-shaped grips extending downward from a lower edge of the conical cover.

2. The baby bottle holder according to claim 1, wherein the grips each have an uneven non-slip surface.

3. The baby bottle holder according to claim 1, wherein the elastic member comprises synthetic resin.

4. The baby bottle holder according to claim 1, wherein the elastic member is transparent or semitransparent.

5. The baby bottle holder according to claim 1, wherein the elastic member has a vivid color.
